(19) United States
(12) Patent Application Publication
(10) Pub. No.: US 2010/0014953 A1
(43) Pub. Date: Jan. 21, 2010

(54) Method and Apparatus for the Formation and Discharge of Ordered Groups of Products, in Particular Rolls of Paper

(75) Inventors: Luca Antoniazzi, Bologna (IT); Nicola Baldanza, Bologna (IT); Andrea Cinotti, Bologna (IT); Nicola Giuliani, Bologna (IT); Giordano Gorrieri, Bologna (IT)

Correspondence Address: BREINER & BREINER, L.L.C., P.O. BOX 320160, ALEXANDRIA, VA, 22320-0160, US

(73) Assignee: KPL Packaging S.p.A., Calderara di Reno, Bologna (IT)

(21) Appl. No.: 11/922,202

(22) PCT Filed: Jun. 13, 2006
(86) PCT No.: PCT/IT2006/000445

§ 371 Date: Dec. 14, 2007

(30) Foreign Application Priority Data
Jun. 17, 2005 (EP) 05425434.7
Jan. 19, 2006 (IT) BO2006A000035

(51) Int. Cl. B65B 35/50; B65G 57/03

(52) U.S. Cl. 414/789.5; 414/802; 414/789.6

(57) ABSTRACT

The formation of a group (2) of rolls (3) of paper arranged according to a first number (h) of overlaid layers (4) is performed by feeding the layers (4) onto an elevator platform (8) by means of at least two feed conveyors (11) positioned one on top of the other; the method providing for initial loading onto the platform (8) of a number of layers (4) at the most equal to the number of feed conveyors (11), lowering of the platform (8) by a distance equal or slightly greater than the height of the layers (4) just loaded and, lastly, loading onto the platform (8) and onto the layers (4) already loaded of a number of layers (4) at the most equal to the number of feed conveyors (11).

### TECHNICAL FIELD

The present invention relates to a method and to an apparatus for the formation and discharge of ordered groups of products.

The present invention is applied particularly advantageously in packaging machines for rolls of paper, to which the following description will explicitly refer without loss of generality.

### STATE OF THE ART

In the packaging machines for rolls of paper, it is known to order rolls in groups consisting of several overlaid layers, each of which is defined by a plurality of rolls ordered according to a plurality of parallel rows.

Each group is formed on an elevator platform, which moves between a lowered position for loading the layers and a raised position for discharging the group to a packaging line of the packaging machine.

The layers are loaded on the platform by means of a plurality of feed conveyors positioned one on top of another, which are operated simultaneously or selectively to form a group consisting of a number of layers at the most equal to the number of feed conveyors.

A machine of this type is described in EP-A-654429 and illustrated in Figure A. Said known machines are provided with a pair of final parallel chain conveyors T1 and T2, positioned one on top of the other, which each support, for example, a pair of thrust cross members B1, B1′ and B2, B2′ spaced from each other at an angle of 180° so that when one cross member reaches the discharge end of a conveyor, the other cross member is positioned on the entry end of the same conveyor. The conveyors T1 and T2 are usually operated by means of a central drive unit and rotate in contrary directions, at the same speed and in such a way that as the respective cross members of said conveyors travel along the lower branch of the conveyor T1 and the upper branch of the conveyor T2, corresponding cross members move at an appropriate distance and above respective fixed sliding surfaces S1 and S2, positioned along said conveyors, so as to push on said surfaces respective products P1, P2 which are simultaneously discharged by said cross members, with reciprocal stacking, onto a horizontal collecting device E aligned with the lower surface S2. The products are fed alternatively onto the surfaces S1, S2 by a parallel chain conveyor T3, which will be hereinafter called pendulum as it oscillates alternatively on an axis horizontal and crosswise to the path of the products, as indicated by the continuous line and broken line; said parallel chain conveyor is also provided with thrust cross members B3 which, as they travel along the upper branch of said conveyor, push the products to run onto a fixed surface S3, integral with the mobile supporting structure of the pendulum, which is alternatively aligned to surfaces P1 and P2 of the conveyors downstream T1, T2. The collecting surface or platform E consists for example of an elevator which, after receiving the two layers of product, performs a lifting stroke, as indicated by the broken line, to place the group of products in a station K which provides for packaging of said products with a sheet F made of thermoplastic material, for example, which, by suitable known devices M, is first closed in a tube shape on the same group of products, after which the elevator returns to the lowered position to repeat another work cycle, while the set of products with the packaging is translated and suitable known devices complete closing of said packaging. According to other embodiments, devices are provided which horizontally translate the products from the horizontal collecting platform E, towards packaging devices equal to or different from those mentioned previously, after which said translation devices return to the rest position to permit the repetition of a new work cycle.

With the machines of the type shown in Figure A it is possible if necessary to feed onto the elevator E and transfer by means thereof to the packaging station K, one single layer of products P1 which are preferably fed to the same elevator by the upper conveyor T1, which is nearer the packaging station, in order to reduce the working stroke of the elevator, while the pendulum T3 remains in the up position to feed only the conveyor T1, as illustrated in Figure B. Figure C illustrates another possibility of use of the machine according to the known technique, which provides for cyclic insertion into the packaging station K of four layers of product by the elevator E which, after receiving from the conveyors T1 and T2 two layers of product P1 and P2, moves down by a distance at least equal to the height of said layers of product, so that it can receive from the conveyors T1, T2 further two layers of product P1′, P2′. In these cases, to rapidly free the elevator E for the repetition of a subsequent work cycle, the pile of the four layers of product can be translated to an adjacent auxiliary elevator which provides for transfer of the products to a packaging station of the type indicated previously by K, so as to reduce down time and increase machine productivity.

With machines of this type it is currently difficult to form piles of three layers of product without modifying the hardware of the machine.

The machine operates as in the solution of FIG. 3, the difference being that in one of the conveyors T1 or T2 an empty space in the product flow is created for a certain distance, so that for each cycle first one single layer or two layers of overlaid products are discharged from said conveyors onto the final elevator, after which the same elevator moves down by the height of one layer of product and two layers or the remaining layer are fed onto the same. According to a preferred embodiment of the invention, the conveyor T1 or T2, which at each cycle discharges one single layer of product, is configured so that one of its thrust cross members can be removed and, via a simple software modification, the machine can feed even three layers of product to the packaging station.

U.S. Pat. No. 3,585,777 describes a device and a method for forming packages consisting of layers of overlaid products, and for packaging the layers with a heat-sealable plastic film. The device has a vertically mobile platform, on which the layers of product to be packaged are positioned one on top of the other, pushed by a pusher device. A protective sheet is positioned between the overlaid layers. Beside the mobile platform a plastic film is positioned which wraps the group of overlaid layers when it is moved away from the platform and pushed against the film positioned vertically. This known device entails lengthy packaging times.

From the above description it can be seen that in the known packaging machines there is always the problem of efficiently and rapidly forming groups of rolls consisting of a number of layers greater than the number of the feed conveyors.

### OBJECTS AND SUMMARY OF THE INVENTION

One object of an embodiment of the present invention is to provide a method for the formation and discharge of ordered groups of products, in particular but not exclusively rolls of paper, which overcomes wholly or partly the drawbacks described above. According to a particular aspect, the object of an embodiment of the invention is to provide a method and a device that are simple and inexpensive, to implement and therefore permit improvement of the versatility of the packaging machines already operating on the market.

According to a first aspect of the present invention a method for the formation and discharge of ordered groups of products is provided, in particular but not exclusively rolls of paper (such as toilet paper rolls and kitchen paper rolls), in Which each group comprises products ordered according to an overall number of overlaid layers, using a packaging machine comprising an elevator moving in a substantially vertical direction between a position for discharging the groups of products, and a feeder device comprising a pre-set number of conveyors positioned substantially one on top of another, suitable for feeding layers of products to the elevator, the number of conveyors being at least equal to two and less than the overall number of layers in said group of products. According to a particular embodiment of the invention, the method comprises the steps of:
initially loading on the elevator a first number of layers at the most equal to the number of conveyors;
lowering the elevator by a distance equal to or slightly greater than the height of the layers of said first number of layers; and
loading on the layers of the first number of layers a second number of layers at the most equal to said number of conveyors, said overall number of layers being equal to the sum of the first number of layers and the second number of layers.

Layer of products can mean a layer containing a plurality of articles aligned substantially on one plane; however, said term can also denote in the context of the present invention a layer containing one single product, since the method and the machine of the present invention can be used advantageously also to form multilayer packages, for example consisting of three layers, each containing one single article.

According to an embodiment of the invention, particularly suitable for packaging rolls of paper or other products that do not easily slide over one another, the method comprises the step of arranging on said first number of layers a protective element to guarantee the stability of the first number of layers while loading said second number of layers on the elevator.

Preferably the elevator transfers the group of products formed on it with an upward movement to an upper packaging area, while not excluding the possibility of providing said elevator with a downward transfer movement, if the packaging line is positioned below the conveyors. A system and a method in which, once the group of products has formed, the elevator is translated laterally with respect to the area in which the conveyors discharge the various layers on the elevator, also fall within the scope of the present invention. In general, the elevator has a vertical movement so that it can receive overlaid layers of products from conveyors positioned one on top of another, but can be provided with any movement to then transfer the group of products to the next station. The term elevator should therefore be understood as referring to the vertical movement that permits loading of the products and re-positioning of the device at each cycle.

According to a particularly advantageous embodiment of the invention, a group of two conveyors substantially positioned one on top of the other is used to produce groups of three layers of products, with depositing on the elevator of a first layer and, after lowering, of two layers simultaneously by the two conveyors, or alternatively first two layers simultaneously by the two conveyors, and then one single layer, after lowering of the elevator.

According to a further aspect, the invention concerns a packaging machine for the formation and discharge of ordered groups of products, each group comprising products ordered according to an overall number of overlaid layers, said machine comprising an elevator moving in a substantially vertical direction between a position for discharging the groups of products and a feeder device comprising, in turn, a number of conveyors substantially positioned one on top of another, to feed layers of products to the elevator, the number of conveyors being at least equal to two and less than the overall number of layers in said group of products; characterized in that said conveyors and said elevator are controlled in such a way as to perform the following phases:
initially load on said elevator a first number of layers at the most equal to the number of conveyors;
lower the elevator by a distance equal to or slightly greater than the height of the layers of said first number of layers; and
load on the layers of said first number of layers a second number of layers at the most equal to said number of conveyors, said overall number of layers being equal to the sum of said first and second number of layers.

According to another aspect, the invention relates to a machine for forming and delivery for packaging groups of products, comprising: a collecting elevator, moving in a substantially vertical direction and controlled to lower itself by a stroke at least equal to the height of a layer of product, to receive in succession several layers of overlaid product and to transfer a plurality of overlaid layers to a packaging station; a pair of conveyors substantially positioned on one top of the other, which discharge respective layers of products onto said collecting elevator; a feeder system to cyclically feed products to said conveyors; characterized in that said conveyors and said elevator are arranged and controlled to perform the following phases in sequence:
discharge onto said elevator one single product layer coming from a first of said conveyors; or two overlaid product layers, one from each of said conveyors;
lower said elevator by a stroke equal at least to the height of the layer or layers discharged;
discharge on said elevator two overlaid product layers, one from each of said conveyors or one single product layer from a second of said conveyors.

The conveyor units can be produced in various ways. For example they can comprise continuous belt or chain conveyors. Preferably, however, they will comprise a sliding surface and a thrust element, for example a chain or other flexible element to which a pusher device or a thrust cross member is connected. In this case, as will be described in detail below, it is possible to modify the conveyor rapidly and easily to use the machine in different configurations and form packages with an even or odd number (for example 1, 2, 3 or 4) of layers of products without the need for prolonged machine standstills.

To distribute the products on the end conveyors which then discharge them onto the elevator, according to an advantageous embodiment of the invention, upstream of said conveyors a pendulum conveyor is provided, which oscillates cyclically around an axis substantially horizontal and substantially crosswise with respect to the path of the products to feed said products alternatively to one or other of said conveyors. Said pendulum conveyor can also advantageously comprise thrust cross members and a sliding surface for said products.

Further advantageous features and embodiments of the method and device according to the invention are indicated in the attached claims.

### BRIEF DESCRIPTION OF THE DRAWINGS

The present invention will now be described with reference to the accompanying drawings, which illustrate non-limiting exemplary embodiments, in which:

Figures A, B, C, already described, show a machine of known type;

FIGS. 1 to 4 are schematic lateral views, with parts removed for clarity, of an embodiment of the packaging machine of the present invention illustrated in four different operating positions;

FIG. 5 is a schematic side elevation view of a different embodiment of the machine according to the invention and illustrated at the beginning of the cycle for forming the three layers of product;

FIGS. 6, 7, 8, 9 and 10 illustrate steps of the work cycle of the machine configured as shown in FIG. 5;

FIG. 11 illustrates, correlated in space, the operating diagrams of the pendulum, the downstream conveyors for the formation of the layers and the elevator in the machine as in FIGS. 5 to 10;

FIGS. 12 and 12a illustrate in block diagrams the feed sequence of the products from the pendulum to the final conveyors and the stacking sequence of said products on the elevator according to the embodiment of FIG. 5, with the upper final conveyor without a thrust cross member;

FIGS. 13 and 13a illustrate in block diagrams a different product feed sequence from the pendulum to the final conveyors, and the corresponding stacking sequence of said products on the elevator, in the case of a variation in which the lower final conveyor is without a thrust cross member;

FIG. 14 illustrates the configuration of the elevator in the case of each layer of product consisting of several products side by side and in the case of the same products being pre-packed in boxes or packaging and having a smooth surface;

FIGS. 15 and 15a illustrate schematically a device for stacking on the elevator successive layers of product in the case of said product having a relatively rough non-sliding surface, for example that of rolls of paper, said device being correlated respectively to the solution of FIGS. 12, 12a and to that of FIGS. 13, 13a;

FIG. 16 is a front elevation view of the device as in FIG. 15.

### DETAILED DESCRIPTION OF EMBODIMENTS OF THE INVENTION

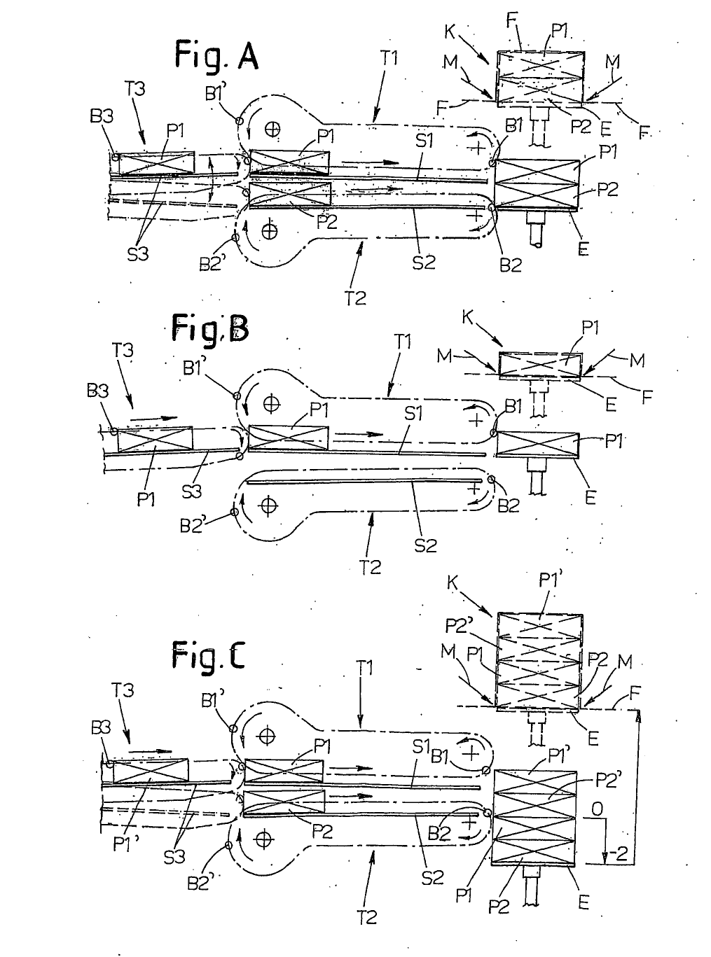

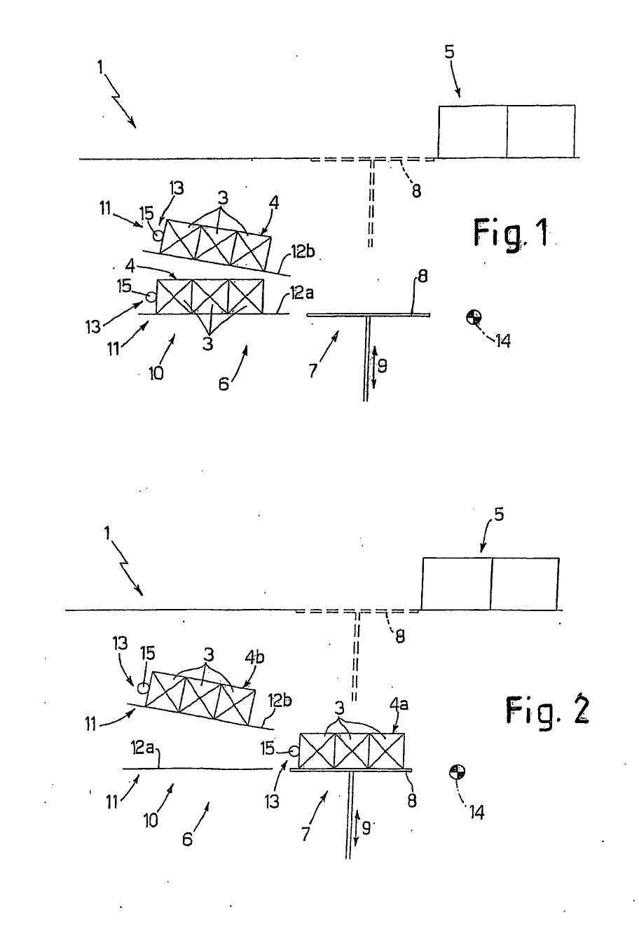

With reference to the FIGS. 1 to 4, 1 indicates, overall, a packaging machine for the packaging of groups 2 of rolls 3 of paper formed each by a respective plurality of rolls 3 ordered according to a set number h of overlaid layers 4 (in our case three layers 4) and, in each layer 4, according to several rows side by side and parallel.

The machine 1 comprises a packaging line 5 of known type, which is suitable for receiving in succession the groups 2 from a forming and discharge unit 6, and for packaging each group 2 inside a wrapping sheet (not illustrated) folded around the group 2.

The unit 6 comprises a device 7 for forming groups 2 of products, comprising in turn a substantially horizontal elevator platform or elevator 8 which moves, driven by an operating device of known type and not illustrated, in a vertical direction 9 from and towards a raised position (illustrated by a broken line in FIGS. 1 to 4) for discharging the groups 2 to the packaging line 5.

The platform or elevator 8 receives the layers 4 from a feeder device 10 comprising a set number k of feed conveyors 11 (in the present case two conveyors 11), which are positioned one on top of another, and extend between the platform or elevator 8, and a distribution device of known type and not illustrated, which is normally common to the conveyors 11, and is suitable for feeding in succession the layers 4 to the conveyors 11. The conveyors 11 comprise respective supporting surface elements 12, one of which (hereinafter indicated by 12a) is positioned below the other (hereinafter indicated by 12b) and is substantially horizontal.

The layers 4 are moved forward along the corresponding element 12a, 12b by means of a thrust device 13 comprising a pair of loop conveyors (not shown), which are arranged by opposite bands of the relative element 12a, 12b in a direction 14 perpendicular to the plane of the sheet of FIGS. 1 to 4, and move in respective vertical planes, and a plurality of drive elements 15 (one only of which is shown for each device 13), which extend between the loop conveyors in the direction 14, are uniformly distributed along the loop conveyors and are suitable for each engaging a respective layer 4 to move it forward towards the platform or elevator 8.

Operation of the machine 1 will now be described with reference to the FIGS. 1 to 4 and starting from the moment when each element 12a, 12b presents a layer 4 (hereinafter indicated by 4a and 4b, respectively) arranged in a transfer position immediately upstream of the platform or elevator 8, and in which the platform or elevator 8 is substantially on the same plane as the element 12a (FIG. 1).

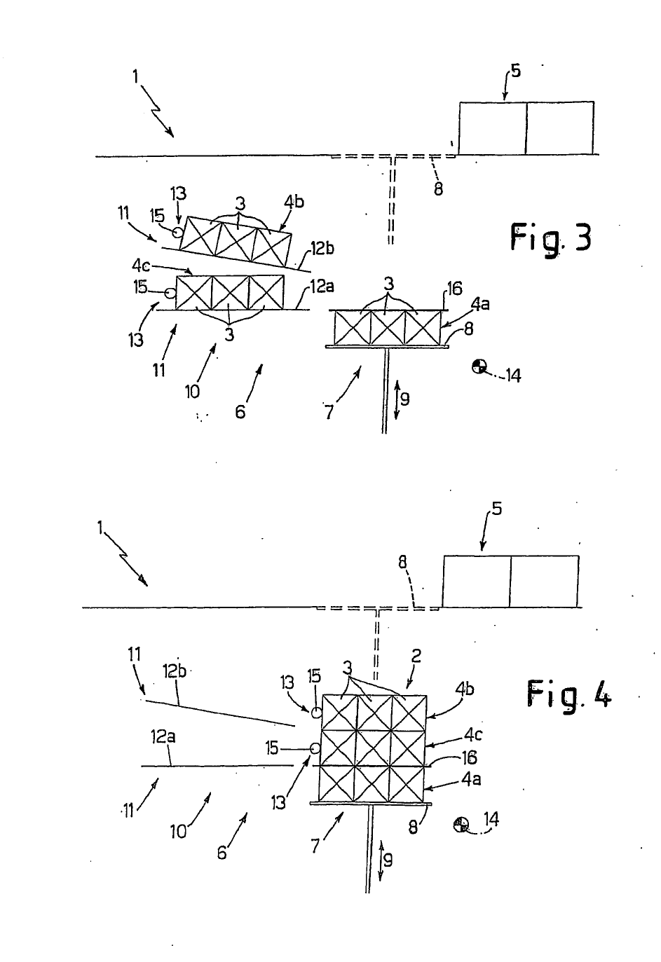

The thrust device 13 associated with the element 12a is operated firstly to load the layer 4a on the platform or elevator 8 (FIG. 2) and then to move forward a new layer 4 (hereinafter indicated by 4c) to the transfer position (FIG. 3), and the platform or elevator 8 is lowered by a distance equal to or slightly greater than the height of the layer 4a measured parallel to the direction 9 (FIG. 3).

At this point, a substantially flat protective element 16 is moved onto the layer 4a to guarantee the stability of the layer 4a, and the devices 13 are operated to move the layers 4b and 4c above the layer 4a (FIG. 4) and on the element 16.

Lastly, the element 16 is disengaged from the layer 4a and the platform or elevator 8 is moved to the raised position for discharging the group 2 to the packaging line 5.

Obviously, each group 2 can be formed by loading on the platform or elevator 8 firstly the layers 4a and 4b and then the layer 4c. Furthermore, the forming device 7 is able to produce groups 2 of rolls 3 consisting of four layers 4 by loading on the platform or elevator 8 firstly the layers 4a, 4b and then the layer 4c, and a further layer 4.

From the above description it follows that the forming device 7 has a relatively high versatility, and permits the formation of groups 2 of rolls 3 consisting of a number of layers 4 greater than the number of conveyors 11.

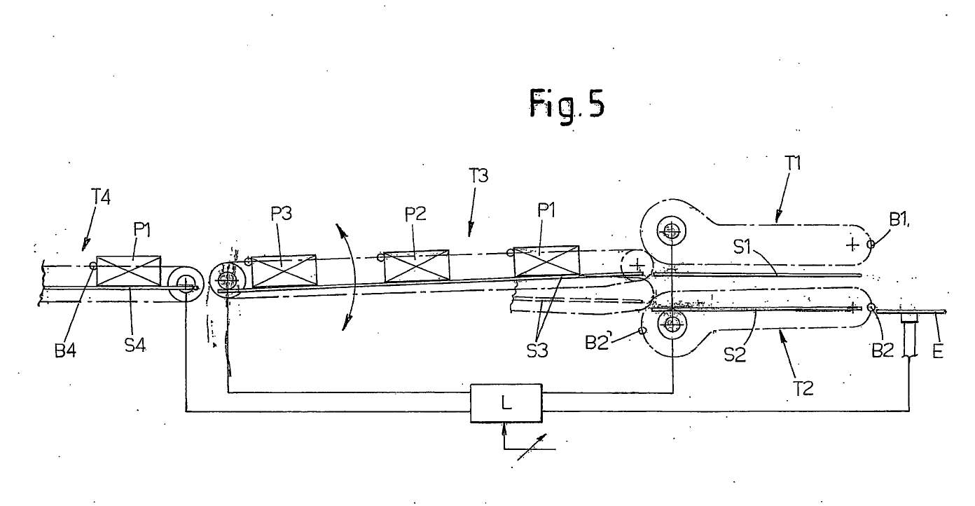

FIGS. 5 to 14a show in greater detail a construction form of a machine or apparatus according to the invention and the related operating method, based on a direct evolution of the machine described above with reference to Figures A, B and C. Equal elements in Figures A, B, C and 5-14 are indicated by the same reference numbers and have already been partly described in the section concerning the state of the art.

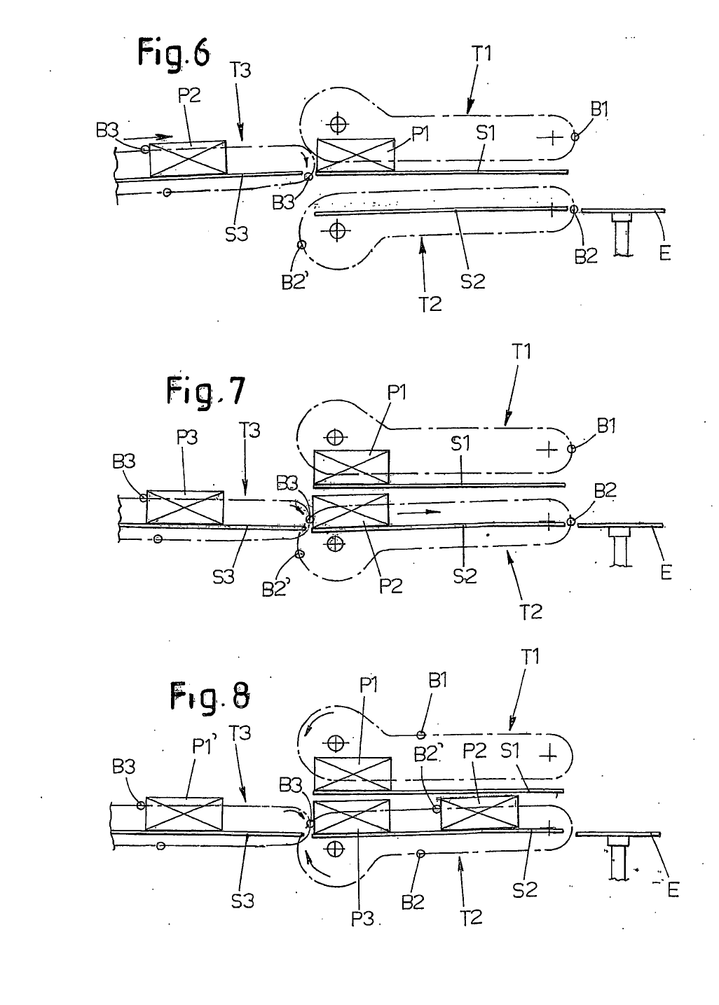

FIG. 5 shows the apparatus according to the invention in the configuration for stacking three layers of product on the elevator or platform E; the same Figure shows, in addition to a pendulum T3 which has already been considered in Figures A, B and C, also the launcher upstream T4 which, for example, is also provided with thrust cross members B4 which push the product P to run over a surface S4 and which feed, with the right timing, the product on the pendulum downstream T3. Alongside the launcher T4 there are other parallel and static launchers, aligned with respective pendulums T3 of several units positioned side by side of the type in question. To configure the machine to operate with the cycle for forming three product layers, the programmer L which controls operation of the main machine components must be modified and if the final conveyors T1 and T2 are synchronized with each other and moved by a central drive (see below), said conveyors must be set to an end or beginning of cycle position, for example with respective cross members B1, B2 at the level of the elevator E which is in the lowered position, for example, and the cross member at the level of the pendulum and operating counter to but synchronized with cross member B2′ of the lower conveyor T2 is removed, for example, from the upper conveyor T1. The cross member which is removed is conveniently positioned for the operation, and will be configured so that it can be easily removed from the connection to the chains of the conveyor T1. The products P1, P2 and P3, which must be fed to the conveyors T1, T2 are, for example, placed on the pendulum T3 in succession. At the beginning of the cycle, the pendulum T3 is in the raised position and feeds the product P1 onto the surface S1 of the upper conveyor T1, as illustrated in FIG. 6, after which the same pendulum is lowered as shown in FIG. 7 and feeds the product P2 onto the surface S2 of the conveyor T2, and the conveyors T1 and T2 are activated, the difference being that while the product P2 is translated towards the elevator E, as illustrated in FIG. 8, the product P1 remains at a standstill as the conveyor T1 is without the cross member B1′ which opposite the cross member B2′ of T2.

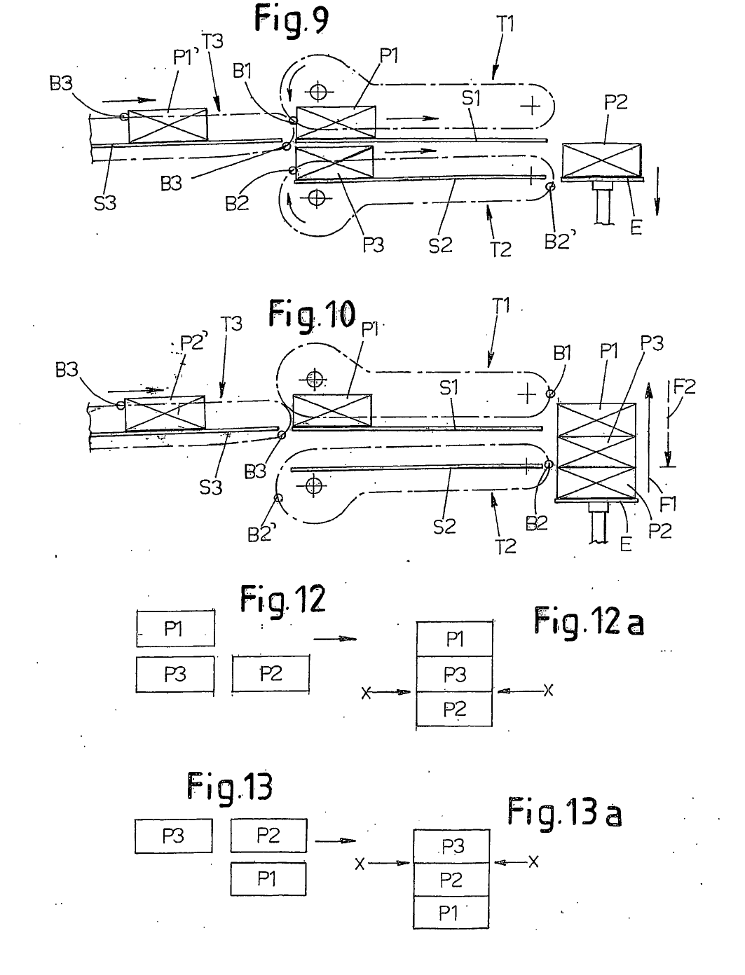

In sequence the pendulum T3 feeds onto the surface S2 of the conveyor T2 also the third product P3, as illustrated in FIG. 8. In sequence, as illustrated in FIG. 9, the product P2 is fed by T2 onto the elevator E, while the products P1 and P3 come into contact at the rear with the respective cross members B1 and B2 of the conveyors T1 and T2 and are translated simultaneously towards the same elevator E which, with the right timing, is lowered by a distance at least equal to the height of the product P2 previously discharged onto said elevator, so that when the conveyors T1 and T2 simultaneously discharge the related products P1 and P3, the latter deposit on the product P3 discharged first, as illustrated in FIG. 10. In this phase, the pendulum T3 goes to the up position to feed a subsequent product P1′ onto the surface S1 of the conveyor T1. At this point it is obvious that, while the phases described previously with reference to FIGS. 6 to 8 are repeated, the elevator E with the pile of products P2, P3, P1 has plenty of time to perform the elevation stroke to place the same products in the packaging station K and to return to the lowered cycle start position, aligned with the surface S2 of T2, as shown in FIG. 10 by the arrows F1 and F2 respectively.

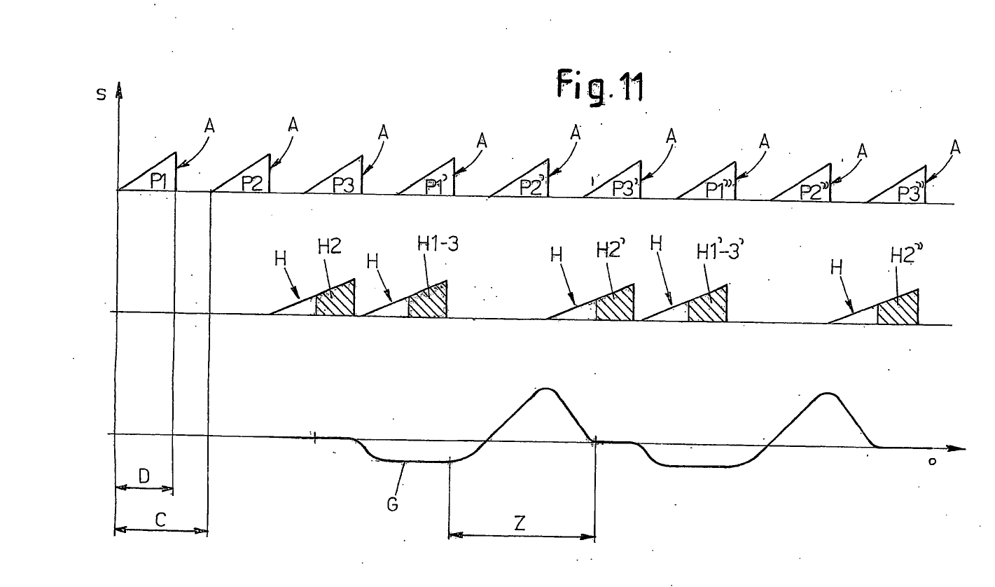

In the diagrams of FIG. 11, the X axis of which indicates the time or the phase angle of the machine, A indicates the cyclic feed curves of the products P1, P2, P3 and successive P1′, P2′, P3′ fed by the pendulum T3, and C indicates the pitch between the products, corresponding to a phase of 120° for example, while D indicates the loading phase of a product on the conveyors downstream T1 and T2. G indicates the stroke of the elevator E. H indicates the curves for feeding of the products by the end conveyors T1 and T2, where the parts highlighted by the hatching and marked H2 indicate first the load of the product P2 on the elevator and then the part marked H1-3 indicates the simultaneous load of the products P1 and P2 on the same elevator E.

It can be noted from the curve G that, after feeding of the first product P2 on the elevator, the latter is lowered by a pre-set distance and remains in the lowered position until the last stacked products P1 and P3 have been translated on it, after which the same elevator is raised to place the products in the packaging station and then lowered again and for the subsequent return stroke in the cycle start position with a phase Z, the amplitude of which is given by the following formula: 360:n−I:P×360:n, where “n” indicates the number of products to be stacked, “I” the length of a product and “P” the pitch between the products.

FIG. 12 shows the feeding order of the products P1, P2 and P3 on the conveyors T1 and T2, as described previously with reference to the FIGS. 5 to 10, while FIG. 12a indicates the order in which the products are stacked on the elevator E. The arrows XX indicate the separation area between the product or the group of products P2 which are discharged first onto the elevator, and the products or groups of products that are discharged last. In the example previously described with reference to the FIGS. 5 to 10, the separation area X is positioned at the level of the sliding surface S2 of the lower conveyor T2. For the reasons explained further on, it may be convenient to position said separation area X at the height of the surface S1 of the upper conveyor T1, and this condition can be obtained by removing a thrust cross member from the lower conveyor T2; it may also be expedient for the feed order of the products from the pendulum T3 to the final conveyors T1, T2 to be as illustrated in FIG. 13, so that the products P1 and P2 are discharged together onto the elevator E in the lowered position followed by product P3 only, now discharged on T1. From FIG. 13a it can be seen that when the elevator E receives from T1, T2 the first group of stacked products P1, P2, the same is controlled to perform the down stroke as in the previous case, so that it then receives only the product P3. It is now obvious that the separation area X between the products, which are discharged first, and the product discharged last is at the height of the surface S1 of the upper conveyor T1.

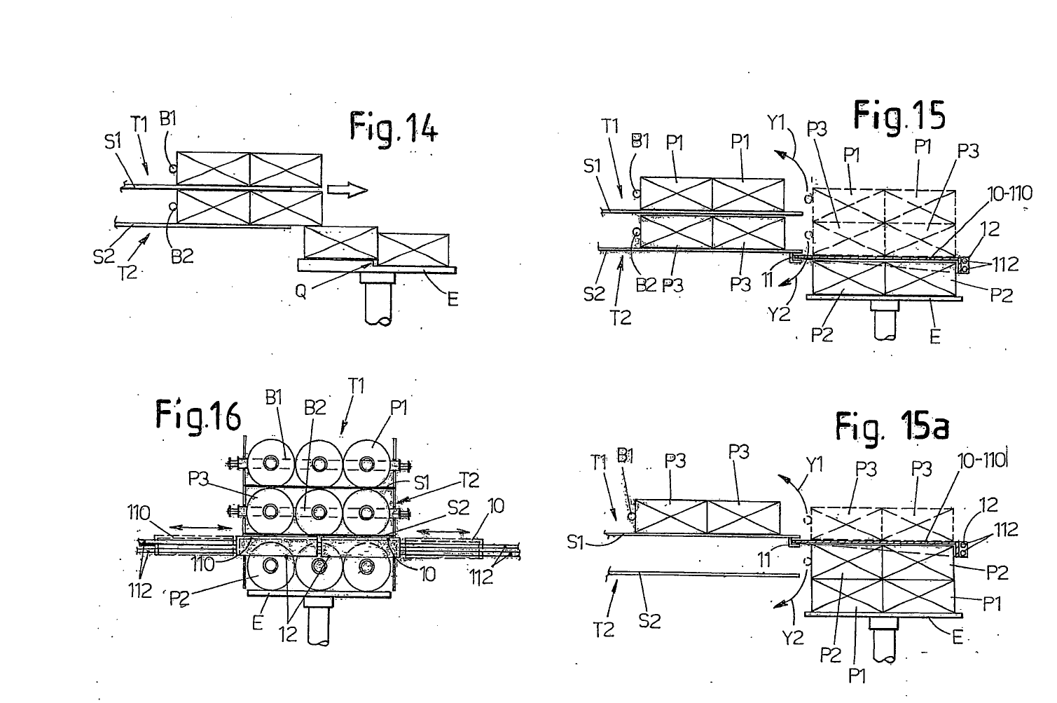

If the products discharged onto the elevator are pre-packed in boxes or packaging with sufficiently smooth outer surface, the product or products discharged last run smoothly over the products discharged first onto the same elevator. In the case of each layer of products consisting of several products positioned one after the other, as in the example of FIG. 14, the elevator E is provided at the top with a step Q of sufficient dimension on its upper face, so that the products upstream which reach the elevator first are lowered with respect to those downstream and do not create potentially raised edges for the products that will follow in the subsequent phase of stratification by the conveyors T1 and T2. If the products to be stratified on the elevator E are not pre-packed and/or if they are in any case characterized by a relatively rough outer surface, such as that of rolls of paper, for example, in the separation area X mentioned previously with reference to FIGS. 12a and 13a, separators with low friction coefficient must be provided, which are positioned as required on the products discharged first onto the elevator, to receive without any interference with the latter the products discharged last, after which said means of separation are moved away from the side play of the elevator to deposit said last products on those below, also due to the containing action exerted by the walls of the vertical hopper in which the elevator moves, not shown in the drawings since it is of known type. In this case the problem of stratification described with reference to FIG. 14 does not exist due to the presence of the separator, hence the upper face of the elevator E can be flat, even when each layer of product is formed of several products positioned one after the other.

From FIGS. 15, 15a and 16 it can be seen that, according to an embodiment that can be applied industrially, said separation means that operate in the separation area X can consist of two horizontal diaphragms 10, 110 for example made of sheet metal, ribbed on two consecutive and outer sides, which with one non-ribbed side, according to the operating hypothesis previously mentioned with reference to FIGS. 12, 12a (FIG. 15) or to FIGS. 13 and 13a (FIG. 15a), slide on guide means 11 associated with the terminal edge of the surface S1 or S2 of the conveyors T1 or T2, while with the other side the same diaphragms 10, 110 are integral with respective carriages 12 which run on horizontal guides 112, fixed and parallel to said guide means 11. Specific self-centering operating devices, not illustrated as they can be easily imagined and produced by persons skilled in the art, are provided to move the separation diaphragms 10, 110 together, meeting on the center line of the elevator E, as illustrated by the continuous line in FIG. 16, to receive the products that are discharged last and avoid interference of the latter with the products below discharged first; means are provided to then re-set the same separation diaphragms to the rest position outside the side play of the elevator, as illustrated in FIG. 16 by the broken line, to allow the elevator to perform the subsequent work phases. From FIG. 16 it is clear that the use of two separators 10, 110 with self-centering movement significantly limits the intervention and neutralization times of these means, while from FIG. 15a it is obvious that, providing for cooperation of the separators with the surface S1 of the upper conveyor T1, it is possible to simplify operation of the device in question, as the return movement Y1 and Y2 of the thrust cross members of the conveyors T1 and T2 does not interfere with the same device even if the latter is in an active position.

According to an executive variation of the invention, said separation diaphragms 10, 110 can be replaced wholly or partly by roller units covered with a respective conveyor belt which at least in the phase of extraction of these components is moved by suitable means in a direction contrary to the extraction direction, and at a speed equal to the extraction speed, so as not to transmit rotation components or undesired friction to the product above. It is understood that the separators operating in area X as per FIG. 12a or 13a can be different from those described, for example they can be of the roller shutter type, supported at opposite ends by appropriately motorized conveyors, or they can be of another suitable type.

Lastly it is understood that the embodiment described with reference to the FIGS. 5 to 10 is a preferred executive embodiment of the invention, in particular when the final conveyors T1 and T2 are synchronized by one single central drive unit. The same results as those illustrated in the diagram of FIG. 11 can be equally obtained by modifying the work program of the launcher T4 of FIG. 5, in order that the latter cyclically creates an empty space in the product flow on the cross members of the pendulum T3, so that these empty spaces result in a corresponding lack of product on the conveyor downstream T1 or T2, operation of which is delayed with respect to the other, even without a thrust cross member having to be removed from said last conveyor, as in the hypothesis formulated with reference to FIG. 5. The same results illustrated in the diagram of FIG. 11 can also be obtained differently by providing for the conveyors T1 and T2 to be driven by independent drive units, so as to conveniently delay the operation of one conveyor with respect to the other, even without removing one of the thrust cross members from it. These solutions should also be considered protected by this patent application, together with what has been said with reference to FIGS. 15, 15a and 16.

It is therefore understood that the description refers to a preferred embodiment of the invention, to which numerous variations and construction modifications can be made, without abandoning the informing principle of the invention, as described above, as illustrated and as claimed below. In the claims the references in brackets are purely indicative and do not limit the protective scope of said claims.

1-28. (canceled)

29. Method for forming and discharging ordered groups of products in a packaging machine, each group of products comprising products ordered according to an overall number of overlaid layers, and the packaging machine comprising an elevator moving in a substantially vertical direction and between a position for discharging the groups of products and a feeder device comprising a predetermined number of conveyors positioned substantially one on top of another for feeding to the elevator layers of products, the number of conveyors being at least equal to two and less than an overall number of layers in said group of products; said method comprising steps of:
initially loading on the elevator a first number of layers which at most equal the number of conveyors;
lowering the elevator by a distance equal to or greater than a height of the layers of said first number of layers; and
loading on the layers of the first number of layers a second number of layers, said second number of layers being different than said first number of layers and at most equal to said number of conveyors; said overall number of overlaid layers being equal to a sum of the first number of layers and the second number of layers.

30. The method as claimed in claim 29, further comprising arranging on said first number of layers a protective element to provide stability to the first number of layers during loading of said second number of layers on the elevator.

31. The method as claimed in claim 30, further comprising disengaging the protective element from the group of products once formation of the group is complete.

32. The method as claimed in claim 31, further comprising moving the elevator to the position for discharging the group of products once the protective element has been disengaged from the group.

33. The method as claimed in claim 29, wherein upon formation of an ordered group of products on the elevator, said elevator is raised towards said position for discharging, which is higher than said feeder device.

34. The method as claimed in claim 29, wherein:
said group of products comprises an overall number of three overlaid layers of products;
said layers are fed by two conveyors positioned substantially one on top of another;
said first number of layers is equal to 2 and said second number of layers is equal to 1, or said first number of layers is equal to 1 and said second number of layers is equal to 2.

35. The method as claimed in claim 29, wherein said first number of layers is equal to said number of conveyors and said second number of layers is less than said number of conveyors; or said first number of layers is less than said number of conveyors and said second number of layers is equal to said number of conveyors.

36. The method as claimed in claim 29, wherein said elevator is movable in a substantially vertical direction between said position for discharging the groups of products and said feeder device.

37. A packaging machine for forming and discharging ordered groups of products, each group of products comprising products ordered according to an overall number of overlaid layers; said packaging machine comprising an elevator moving in a substantially vertical direction and between a position for discharging the groups of products and a feeder device comprising, in turn, a number of conveyors positioned substantially one on top of another, to feed to the elevator layers of products, the number of conveyors being at least equal to two and less than the overall number of layers in said group of products; wherein said conveyors and said elevator are constructed and arranged to perform the following steps:
initially load on said elevator a first number of layers which at most equal the number of conveyors;
lower the elevator by a distance equal to or greater than a height of the layers of said first number of layers; and
load on the layers of said first number of layers a second number of layers, said second number being different than said first number of layers and which at most equal said number of conveyors; said overall number of layers being equal to a sum of said first number of layers and said second number of layers.

38. The machine as claimed in claim 37, wherein said position for discharging is higher than said feeder device.

39. The machine as claimed in claim 37, further comprising a protective element that can be positioned between layers loaded sequentially on said elevator.

40. The machine as claimed in claim 37, wherein said elevator moves substantially vertically between said feeder device and said position for discharging the groups of products.

41. A machine to form and send for packaging groups of products comprising a collecting elevator moving according to a substantially vertical direction and constructed and arranged to lower itself by a stroke at least equal to a height of a layer of product to receive a plurality of overlaid product layers in succession and to transfer a plurality of overlaid layers to a packaging station; a pair of conveyors positioned substantially one on top of another which discharge respective layers of product onto said collecting elevator; a feeder system to cyclically feed products to said conveyors; wherein said conveyors and said elevator are positioned and arranged to perform in sequence steps as follows:
a. discharge onto said elevator one single layer of product coming from a first of said conveyors or two layers of overlaid products, one from each of said conveyors;
b. lower said elevator by a stroke at least equal to the height of the layer or layers discharged;
c. if a single layer is discharged in step a., discharge onto said elevator two layers of products overlaid, one from each of said conveyors; or, if two layers are discharged in step a., discharge onto said elevator one single layer of product from a second of said conveyors.

42. The machine as claimed in claim 41, wherein said conveyors comprise thrust cross members which push the product over respective surfaces to discharge respective layers of product onto said collecting elevator.

43. The machine as claimed in claim 41, wherein upstream of said conveyors is a pendulum conveyor which oscillates cyclically around an axis substantially horizontal and substantially crosswise with respect to a path of the products in order to feed said products alternatively to one or the other of said conveyors.

44. The machine as claimed in claim 43, wherein upstream of said pendulum conveyor is a launcher which feeds said products synchronized with said pendulum conveyor.

45. The machine as claimed in claim 43, wherein said pendulum conveyor comprises thrust cross members and a sliding surface for said products.

46. The machine as claimed in claim 43, wherein the conveyors are synchronized and moved by a single drive unit, and wherein said conveyors are configured so that a thrust cross member can be removed from at least one of said conveyors, such that when a layer of products is fed to said conveyor, said layer of products remains in the conveyor while the other conveyor performs a stroke to transfer a respective layer of products towards the elevator, thus permitting feeding of three layers of product onto said elevator.

47. The machine as claimed in claim 46, wherein an upper conveyor is without a thrust cross member; said pendulum conveyor is arranged to feed in sequence a first layer of products to the upper conveyor; a second layer of products to a lower conveyor; and lastly a third layer of products to the lower conveyor; and the conveyors are controlled so that stacking order of the layers of products on the elevator, starting from bottom, consists of a sequence of second layer, third layer and first layer.

48. The machine as claimed in claim 46, wherein a lower conveyor is without a thrust cross member; said pendulum conveyor is arranged to feed in sequence a first layer of products to said lower conveyor, a second layer of products to an upper conveyor and a third layer of products to said upper conveyor; and said conveyors are controlled so that stacking order of the layers of products on the elevator, starting from bottom, is by sequence first layer, second layer and third layer.

49. The machine as claimed in claim 44, further comprising means for modifying a work program of the launcher, so that said means creates, cyclically and with proper timing, an empty space in product flow on the pendulum conveyor in order that each said empty space determines a corresponding lack of product on the conveyor downstream operation of which must be delayed with respect to the other conveyor.

50. The machine as claimed in claim 41, further comprising independent drive units for the conveyors and said drive units are electronically controlled by a programmable control unit so as to delay operation of one conveyor with respect to the other conveyor.

51. The machine as claimed in claim 41, wherein the elevator has a step.

52. The machine as claimed in claim 41, further comprising at least a separator inserted in a separation area between the layer or the layers discharged first and those discharged last onto said elevator, said separator being positionable above the layer or the layers discharged first onto the elevator before discharge of a subsequent layer or layers, and which can be removed from side play of the elevator.

53. The machine as claimed in claim 52, wherein said separator comprises at least two components with a reciprocal approach and withdrawal movement.

54. The machine as claimed in claim 53, wherein said components consist of horizontal diaphragms predeterminedly ribbed with outer sides, guided and supported by external operating slides which run on horizontal guides, driven by a self-centering operating device.

55. The machine as claimed in claim 52, wherein said separator comprises roller units with a conveyor belt which at least in a separator extraction phase moves in a direction contrary to an extraction direction and at a speed equal to extraction speed, so as not to transmit rotation components or undesired friction to the layer of products above.

56. The machine as claimed in claim 52, wherein the separator comprises a roller shutter supported at opposite ends by motorized conveyors.
